(19) United States
(12) Patent Application Publication
(10) Pub. No.: US 2014/0367021 A1
(43) Pub. Date: Dec. 18, 2014

(54) METHOD FOR PRODUCING A CORD-SHAPED COMPOSITE MATERIAL AND SYSTEM

(71) Applicant: Bayer Intellectual Property GmbH, Monheim (DE)

(72) Inventors: Stephan Schleiermacher, Pulheim (DE); Joachim Wagner, Köln (DE); Thomas Kleiner, Odenthal (DE); Klaus-Peter Niermann, Balingen (DE); Lothar Wolf, Leverkusen (DE)

(21) Appl. No.: 14/366,279

(22) PCT Filed: Dec. 19, 2012
(86) PCT No.: PCT/EP2012/076189

§ 371 Date: Jun. 18, 2014

(30) Foreign Application Priority Data
Dec. 21, 2011 (EP) 11195050.7

(51) Int. Cl. B29C 70/52

(52) U.S. Cl. CPC B29C 70/525; B29C 70/521; B29K 2075/00
USPC 156/73.2; 156/180; 156/379.6

(57) ABSTRACT

The invention relates to a method and to a pultrusion system (1) for producing a cord-shaped compound element (10) from a fiber bundle (11) and at least one filling component (12, 13), wherein the fiber bundle is guided into an injection box (14) having at least two supply channels (29) and an injection chamber (15), into which chamber die filling component (12, 13) is injected in a fluid state, such that the fiber bundle (11) is saturated with the filling component (12, 13) and whereby a material compound (16) is formed. According to the invention, energy is introduced in the injection chamber (15), such that the fiber bundle (11) is saturated with the filling component (12, 13) while energy is supplied.

The present invention relates to a process for the production of a strand-shaped composite product made of a fiber bundle and of at least one filler component, where the fiber bundle is passed into an injection box with an injection chamber into which the filler component is injected in a flowable state in such a way that the fiber bundle is saturated by the filler component thus forming a composite material.

WO 2007/107007 A1 discloses a process for the production of a strand-shaped composite product made of a fiber bundle, and the process is carried out with what is known as a pultrusion system. The pultrusion system has an injection box through which a bundle made of glass fibers is drawn.

The glass fibers are drawn into the injection box, and in the injection chamber of the injection box the glass fibers are saturated by two filler components. Filler components stated are a polyisocyanate and a polyol. The two filler components are passed through a feed system into the injection box, and the feed system can meter the two filler components into one another and in particular mix them with one another. In the injection box, the two filler components react with one another by way of example to give a polyurethane and at the same time the fibers of the fiber bundle are saturated, and in particular the filler components can wet the fiber bundles. The reaction of the filler components can by way of example produce a polyurethane, in such a way that the composite product is composed of glass fibers in a polyurethane matrix.

After passage through the injection box, the resultant composite material is introduced into a cooling unit and then into a heating unit, and at the same time shaping of the composite product takes place, in such a way that this can by way of example take the form of strand profile when it leaves the pultrusion system. At the end of the units there is a traction device which initially draws the fiber bundle into the injection box, and the composite material is then drawn through the process units that follow.

EP 1 960 184 B1 reveals an injection box with an injection chamber through which the fiber bundle is drawn, and in which the fiber bundle is saturated by filler components. At the entry side, the injection box has a guide plate with, arranged in a matrix, holes through which the fibers of the fiber bundle have been passed. In the injection chamber, the fibers are saturated by the filler components, and they then pass through a region of decreasing cross section of the injection chamber, which is followed by a curing die.

EP 513 927 A1 describes the production of plastics profiles by a pultrusion process. To the extent that the plastics there are produced from two components, ultrasound is used in that process to improve the mixing of the two components.

Disadvantageously, the velocity at which the fiber bundles are drawn through the injection box is restricted because the permissible draw velocity selected cannot be greater than that which ensures complete saturation of the fibers of the fiber bundle by the at least one filler component. In particular, it is necessary to ensure that complete wetting of the fibers by the filler component takes place, and it has been found that drawing of the fiber bundle through the injection box at an excessive velocity can cause formation of bubbles, with the resultant possibility of defects in the composite product. It is therefore necessary to avoid formation of bubbles, and this necessity determines the maximal velocity at which the fiber bundles are drawn through the injection box. At the same time, the velocity at which the fiber bundle is drawn through the injection box here determines the velocity at which the extruded composite product can be provided through the pultrusion system.

Pultrusion velocities that can be achieved in particular during the production of polyurethane composite products based on the addition of polyisocyanate and polyol as filler components, with an injection box of length for example 400 mm, are by way of example at most 0.5 m/min However, a higher velocity would be desirable for design of a less expensive pultrusion process. However, at higher process velocities, air bubbles form in the event of incomplete wetting of the fibers of the fiber bundle by the polyurethane, and brittle composites can be produced which by way of example are in the form of profiles and do not withstand prescribed loadings.

It is therefore the object of the present invention to provide a process which permits the production of a composite product made of a fiber bundle and at least one filler component at increased velocities, while at the same time not impairing the advantageous mechanical properties of the composite product. A particular object is to provide an injection box for a pultrusion system which allows higher process velocity. Finally, the present invention has the object of providing a pultrusion system which avoids formation of bubbles in the composite product at higher process velocities.

Said object is achieved by providing a process for the production of a strand-shaped composite product made of a fiber bundle and of at least one filler component, where the fiber bundle is passed into an injection box with an injection chamber into which the filler component is injected in a flowable state in such a way that the fiber bundle is saturated by the filler component thus forming a composite material, where energy is introduced into the injection chamber in such a way that the saturation of the fiber bundle by the filler component is carried out with introduction of energy, where the injection of the filler components and the introduction of the energy take place in a manner that is mutually independent.

Said object is achieved by providing a process for the production of a strand-shaped composite product made of a fiber bundle and of at least one filler component, where the fiber bundle is passed into an injection box with an injection chamber into which the filler component is injected in a flowable state in such a way that the fiber bundle is saturated by the filler component thus forming a composite material, where energy is introduced into the injection chamber in such a way that the saturation of the fiber bundle by the filler component is carried out with introduction of energy, where the injection of the filler components and the introduction of the energy take place in a manner that is spatially independent, in such a way as to prevent formation of bubbles on the fiber bundle.

Said object is likewise achieved by providing a process for the production of a strand-shaped composite product made of a fiber bundle and of at least one filler component, where the fiber bundle is passed into an injection box with an injection chamber into which the filler component is injected in a flowable state in such a way that the fiber bundle is saturated by the filler component thus forming a composite material, where energy is introduced into the injection chamber in such a way that the saturation of the fiber bundle by the filler component is carried out with introduction of energy, where the position of injection of the filler components differs from the position of introduction of the energy, in such a way as to prevent formation of bubbles on the fiber bundle.

The invention includes the technical teaching to the effect that energy is introduced into the injection chamber, in such a way that the saturation of the fiber bundle by the filler component is carried out with introduction of energy. It is preferable that the energy is introduced in the form of waves selected from the group consisting of microwaves, ultrasound, high-frequency waves, and shockwaves into the injection chamber.

The invention is based on the inventive concept that the formation of bubbles at elevated process velocity for the saturation of the fiber bundle by the at least one filler component can be mitigated or prevented if the saturation of the fiber bundle by the filler component takes place with introduction of energy. It is not necessary that the energy introduced here takes the form only of heat introduced to increase temperature: the energy can by way of example also instead be introduced in the form of oscillatory excitation via introduction of sound and/or of electromagnetic radiation into the injection chamber.

In one advantageous embodiment of the process, the energy can be introduced via ultrasound oscillation into the injection chamber. To this end, use can be made of an ultrasound generator, designed peripherally to the injection box or as constituent of the injection box. The ultrasound oscillation is in particular introduced into the injection chamber of the injection box in such a way that the filler component and/or the fibers of the fiber bundle are excited by the ultrasound oscillation. The frequency of the ultrasound oscillation can preferably be at least 16 kHz to at most 1 GHz, particularly preferably at least 16 kHz to 1 MHz. However, for the purposes of the present invention, it is also possible to use hypersound to introduce the energy into the injection chamber, when by way of example the sound frequency is greater than 1 GHz.

The wavelength of the ultrasound oscillation can advantageously have a value that is greater than the value of the diameter of the fibers of the fiber bundle. This achieves the advantage that the ultrasound oscillation is not scattered at the fibers of the fiber bundle, and spatial penetration of the injection chamber by the ultrasound oscillation is in essence ensured. The ultrasound oscillation can in particular penetrate as far as the core of the fiber bundle in which bubble formation preferentially occurs, and can be avoided by using energy introduced via ultrasound. The manner in which energy is introduced, based on ultrasound oscillation, therefore ensures that the introduction of energy is not merely peripheral, but instead the energy introduced passes through the fiber bundle and accompanies the saturation of the fiber bundle by the filler component across the entire cross section of the resultant composite material and consequently of the resultant composite product, in such a way that this can be produced without bubbles even at elevated pultrusion velocity.

The energy can advantageously be introduced by means of at least one ultrasound transducer into the injection chamber, and the ultrasound transducer can preferably have been designed so as to protrude in the form of ultrasound probe into the injection chamber. In addition or as an alternative, a part of the injection box can have been designed as ultrasound transducer, that part being by way of example amenable to ultrasound oscillation, and the ultrasound oscillation can be transmitted to the at least one filler component. In particular, that part of the injection box that has been designed as ultrasound transducer can form an inner wall of the injection box which delimits the injection chamber. If the ultrasound transducer has been designed as ultrasound probe, the ultrasound probe can protrude into the injection chamber in such a way that the ultrasound probe penetrates the fiber bundle by way of example as far as the core of the fiber bundle. In a particularly advantageous possibility, there can be a plurality of ultrasound probes provided which protrude, by way of example with regular separating distances, into the injection chamber. The ultrasound probes can protrude into the injection chamber from at least two sides of the injection box. The ultrasound transducer can have connection to an ultrasound generator for producing the ultrasound oscillation in the ultrasound transducer.

It is also advantageous that the energy is introduced into the injection chamber in the vicinity of the fiber bundles. By way of example, the ultrasound transducer can be arranged into the injection chamber in the vicinity of the fiber bundles. The filler component can be introduced into the injection chamber from an injection line by use of an increased pressure, or atmospheric pressure can be used to charge the at least one filler component to the injection chamber. For the injection of the filler component there can by way of example be an appropriate aperture provided in the injection box through which, using atmospheric pressure, the at least one filler component is charged to the injection chamber. In another embodiment, injection pipes can protrude at least to some extent into the injection chamber, the filler component being charged into the injection chamber from the ends of these or at various points along the pipe length. The injection pipes can advantageously themselves not be designed as ultrasound probes: any injection pipe designed as ultrasound probe therefore only has the function of injection of the filler component.

If the energy is introduced into the injection chamber via ultrasound oscillation, ultrasound can cause the fibers of the fiber bundle to vibrate, in particular when the filler component saturates the fibers. The ultrasound oscillation here can be transmitted initially from the ultrasound transducer to the filler component, so that it can then be transmitted from the filler component to the fibers of the fiber bundle. It can therefore be sufficient to arrange the ultrasound transducer in such a way that the surface of the ultrasound transducer is brought into contact with the filler component.

As an alternative or in addition to the introduction of energy by means of ultrasound oscillation, it is possible to introduce the energy via microwave radiation into the injection box. The wavelength of the microwave radiation here can be selected in such a way that this likewise penetrates as far as the core of the fiber bundle that has preferably already been saturated by the filler component. It is preferable to use microwave radiation in the range from 1 GHz to 300 GHz. The pultrusion velocity depends inter alia on the nature and the geometry of the composite product to be produced, and can therefore vary. However, a feature of the process of the invention is in particular that the velocity at which the fiber bundle passes through the injection box is preferably at least 1 m/min, particularly preferably at least 1.4 m/min, and very particularly preferably at least 2 m/min. A feature of the process is therefore that the pultrusion velocity is preferably greater than 1 m/min, in particular when the length of the injection box is by way of example 400 mm.

Once the fiber bundle has passed through the injection box and has been saturated by the at least one filler component, a composite material is provided which can then be introduced into a process step for shaping and moreover then a process step for curing. In particular, after the composite material leaves the injection box it can first pass through a cooling unit, where the composite material leaving the injection box in essence already corresponds to the profile of the actual composite product. If the at least one filler component, for example composed of a polyurethane, has been converted to the desired profile shape, passage through the cooling unit can be followed by at least one curing unit where thermal energy is introduced into the composite material, where the introduction of the energy is provided for the curing of the composite material via thermal energy, in that by way of example a curing die is appropriately heated. It is preferable that the filler component comprises no compounds having cyano groups.

The object of the present invention is further achieved via an injection box for a pultrusion system for the production of a strand-shaped composite product made of a fiber bundle and of at least one filler component, where the injection box has at least two feed channels and one injection chamber into which the fiber bundle runs and into which the filler component can be injected in a flowable state, where the invention provides that the injection box has means for introducing energy into the injection chamber in such a way that saturation of the fiber bundle by the filler component can be implemented with introduction of energy, where the means for energy introduction do not serve simultaneously as feed channels. The means can be composed of at least one ultrasound transducer, in particular designed as ultrasound probe and/or designed as part of the injection box. As an alternative or in addition, the means can be composed of at least one microwave generator.

The present invention further provides a pultrusion system with an injection box with features, the box being as described together with the respective advantages above.

Other measures that improve the invention are presented in more detail below together with the description of a preferred embodiment of the invention with reference to the figures.

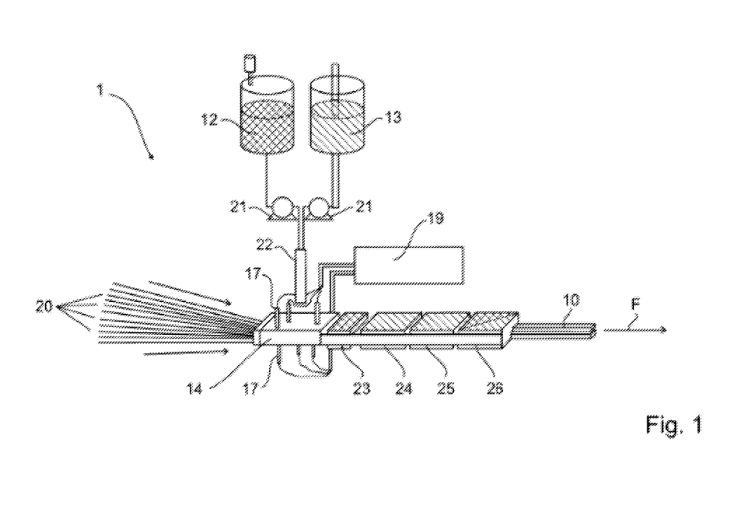

FIG. 1 is a diagram of a pultrusion system for the production of a strand-shaped composite product with an injection box and with an ultrasound generator for the introduction of energy into the injection box and

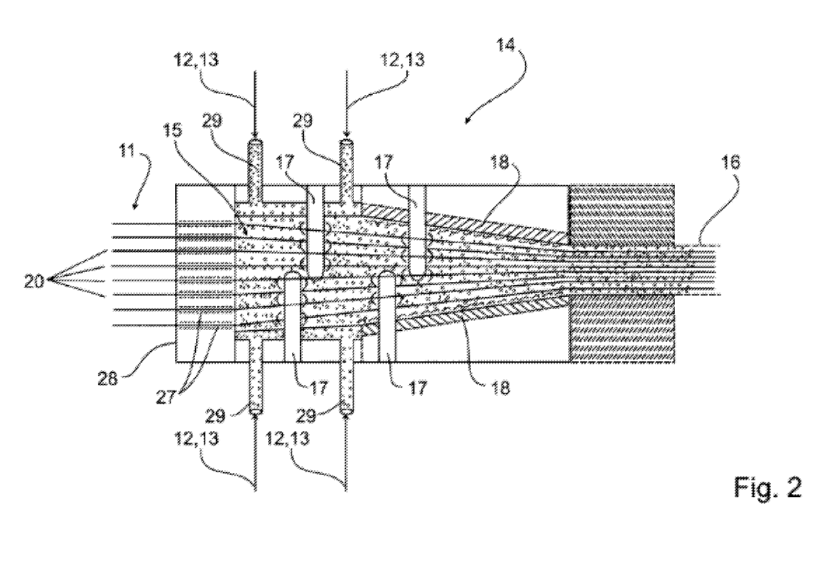

FIG. 2 shows a cross-sectional view of an embodiment of an injection box with ultrasound transducers for the introduction of energy.

FIG. 1 is a diagram of a pultrusion system 1 with an injection box 14, and the injection box 14 has functional connection to an ultrasound generator 19 in order to introduce, by way of ultrasound transducers 17, energy in the form of ultrasound oscillation into the injection box 14.

A fiber bundle 11 is running into the injection box 14, and the fiber bundle 11 has a plurality of fibers 20. The fibers 20 are drawn by a traction force F into the injection box 14, and this traction force F is introduced into the finished composite product 10 which is leaving the pultrusion system 1 with a given profile. In the injection box 14, the fiber bundle 11 is saturated by filler components 12 and 13. The filler component 12 can by way of example comprise a polyisocyanate, and the filler component 13 can comprise a polyol. The two filler components 12 and 13 are metered into one another through metering means 21 in a prescribed ratio and then injected by way of an extrusion mixer 22 into the injection box 14, and this injection of the filler components 12 and 13 via the extrusion mixer 22 can take place under pressure or without pressure.

Once the fiber bundle 11 has passed through the injection box 14, the fibers 20 of the fiber bundle 11 have been saturated by the filler components 12 and 13, and by way of example the fibers 20 can have been introduced within a polyurethane matrix which forms in the injection box 14 through a reaction of the filler components polyisocyanate 12 and polyol 13.

The resultant composite material then passes through a cooling unit 23, and at the outlet of the injection box 14 at least one matrix may have been introduced in order to mould the composite material to give a composite product 10. Downstream of the cooling unit 23, the resultant composite material passes through a plurality of heating and cooling units 24, 25 and 26.

In order to introduce energy into the injection box 14 to accompany the wetting of the fiber bundle 11 by the filler components 12 and 13, there are by way of example a plurality of ultrasound transducers 17 shown, connected to the ultrasound generator 19. An example of an arrangement of the ultrasound transducers 17 on and in the injection box 14 is shown in more detail in the FIG. 2 that follows.

FIG. 2 shows a cross section through an injection box 14 to which a fiber bundle 11 made of a plurality of fibers 20 is running. The fibers 20 here pass through holes 27 introduced within a frontal guide plate 28. The fibers 20 then pass into an injection chamber 15 of the injection box 14.

By way of example, a plurality of feed channels 29 have been shown in a frontal section of the injection chamber 15, and through these the filler components 12 and 13, previously mixed with one another, are introduced into the injection chamber 15. The mixture of the filler components 12 and 13 saturates the fibers 20 of the fiber bundle 11 here, in such a way that the wetting of the fibers 20 takes place during passage of the fibers 20 through the injection chamber 15.

The saturation of the fibers 20 by the filler components 12 and 13 is accompanied by introduction of energy by way of ultrasound probes 17 which are shown by way of example as sonotrodes and protrude into the injection chamber 15. When the ultrasound probes 17 are activated via the ultrasound generator 19, the ultrasound oscillation is transmitted to the mixture of the filler components 12 and 13, and finally the ultrasound oscillation is transmitted from the filler components 12 and 13 to the fibers 20.

Formation of bubbles at the interface between the fibers 20 and the filler components 12 and 13, which may already have been mixed with one another to give a polyurethane, is mitigated or avoided by the ultrasound oscillation introduced, in such a way as to allow an increase of the velocity at which the fiber bundle 11 is drawn through the injection chamber 15.

By way of example, further ultrasound transducers 18 are shown, designed as parts 18 in the periphery of the injection box 14. These parts 18 have been shown by way of example with flat shapes, and ultrasound oscillation can likewise be caused in these via an ultrasound generator 19, in order that this oscillation can be transmitted to the filler components 12 and 13 in the interior of the injection chamber 15.

A composite material 16 is thus provided which has no air inclusions, although the fiber bundle 11 has been drawn at higher velocity through the injection box 14, and high quality of a resultant composite product 10 is thus possible despite the increased pultrusion velocity.

The working of the invention is not restricted to the embodiment stated above, which is merely preferred. In fact, there are a number of conceivable variants which also make use of the solution described in embodiments of fundamentally different type. All of the features and/or advantages apparent from the claims, from the description, or from the drawings, inclusive of design details or spatial arrangements, can be significant for the invention, either on their own or else in the widest possible variety of combinations.

### KEY

1 Pultrusion system
10 Composite product
11 Fiber bundle
12 First filler component
13 Second filler component
14 Injection box
15 Injection chamber
16 Composite material
17 Ultrasound transducer, ultrasound probe
18 Ultrasound transducer, part of injection system
19 Ultrasound generator
20 Fiber
21 Metering means
22 Extrusion mixer
23 Cooling unit
24 Heating unit
25 Heating unit
26 Heating/cooling unit
27 Hole
28 Guide plate
29 Feed channel
F Traction force

1.-15. (canceled)

16. A process for the production of a strand-shaped composite product made of a fiber bundle and of at least one filler component, comprising passing the fiber bundle into an injection box with an injection chamber into which the filler component is injected in a flowable state in such a way that the fiber bundle is saturated by the filler component thus forming a composite material,
wherein energy is introduced into the injection chamber in such a way that the saturation of the fiber bundle by the filler component is carried out with introduction of energy, where the injection of the filler components and the introduction of the energy take place in a manner that is mutually independent.

17. The process as claimed in claim 16, wherein the energy is introduced in the form of waves selected from the group consisting of microwaves, ultrasound, high-frequency waves, and shockwaves into the injection chamber.

18. The process as claimed in claim 16, wherein the energy is introduced via ultrasound oscillation into the injection chamber.

19. The process as claimed in claim 18, wherein the wavelength of the ultrasound oscillation has a value that is greater than the value of the diameter of the fibers of the fiber bundle.

20. The process as claimed in claim 16, wherein the energy is introduced by means of at least one ultrasound transducer into the injection chamber where the ultrasound transducer has preferably been designed as ultrasound probe protruding into the injection chamber and/or as part of the injection box.

21. The process as claimed in claim 18, wherein the ultrasound oscillation causes the fibers of the fiber bundle to vibrate, in particular when the filler component saturates the fibers.

22. The process as claimed in claim 21, wherein the ultrasound oscillation is transmitted from the ultrasound transducer by way of the filler component to the fibers of the fiber bundle.

23. The process as claimed in claim 16, wherein the energy is introduced via microwave radiation into the injection chamber.

24. The process as claimed in claim 16, wherein the velocity at which the fiber bundle passes through the injection box is at least 1 m/min.

25. The process as claimed in claim 16, wherein after the composite material leaves the injection box it is introduced into at least one process step for shaping and at least one process step for curing.

26. An injection box for a pultrusion system for the production of a strand-shaped composite product made of a fiber bundle and of at least one filler component , where the injection box has at least two feed channels and one injection chamber into which the fiber bundle runs and into which the filler component can be injected in a flowable state, wherein the injection box has means for introducing energy into the injection chamber in such a way that saturation of the fiber bundle by the filler component can be implemented with introduction of energy, where the means for energy introduction do not serve as feed channels.

27. The injection box as claimed in claim 26, wherein the means are composed of at least one ultrasound transducer, in particular designed as ultrasound probe and/or designed as part of the injection box.

28. The injection box as claimed in claim 26, wherein the means are composed of at least one microwave generator.

29. The injection box as claimed in claim 26 for carrying out a process as claimed in claim 16.

30. A pultrusion system with an injection box as claimed in claim 26.
